(19) United States
(12) Patent Application Publication
(10) Pub. No.: US 2026/0213985 A1
(43) Pub. Date: Jul. 23, 2026

(54) REFERENCE SYNCHRONIZATION SIGNAL BLOCK FOR USER EQUIPMENT MOBILITY

(71) Applicant: QUALCOMM Incorporated, San Diego, CA (US)

(72) Inventors: Prashant SHARMA, San Marcos, CA (US); Nazmul ISLAM, Littleton, MA (US); Chun-Hao HSU, San Jose, CA (US); Akshaya MITTAL, Hyderabad (IN)

(21) Appl. No.: 19/139,155

(22) PCT Filed: Feb. 13, 2024
(86) PCT No.: PCT/US2024/015548

§ 371 Date: Jun. 13, 2025

(30) Foreign Application Priority Data
Feb. 17, 2023 (IN) 202341010797

(51) Int. Cl. H04L 27/26; H04W 36/00

(52) U.S. Cl. CPC H04L 27/26025; H04W 36/0072; H04W 36/0085

(57) ABSTRACT

Various aspects of the present disclosure generally relate to wireless communication. In some aspects, a user equipment (UE) may identify, for a handover between a serving cell and a target cell, whether a center frequency and sub-carrier spacing (SCS) of a reference synchronization signal block (SSB) for the serving cell are the same, respectively, as a center frequency and SCS of a reference SSB for the target cell. The UE may initiate a handover from the serving cell to the target cell using one or more intra-frequency measurements or handover conditions based at least in part on the center frequency and SCS of the reference SSB for the serving cell being the same, respectively, as the center frequency and SCS of the reference SSB for the target cell, or otherwise, using one or more inter-frequency measurements or handover conditions. Numerous other aspects are described.

### CROSS-REFERENCE TO RELATED APPLICATION

This Patent application claims priority to India patent application No. 202341010797, filed on Feb. 17, 2023, entitled “REFERENCE SYNCHRONIZATION SIGNAL BLOCK FOR USER EQUIPMENT MOBILITY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for reference synchronization signal block for user equipment mobility.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include identifying, for a handover between a serving cell and a target cell, whether a center frequency and sub-carrier spacing (SCS) of a reference synchronization signal block (SSB) for the serving cell are the same, respectively, as a center frequency and SCS of a reference SSB for the target cell. The method may include initiating a handover from the serving cell to the target cell using one or more intra-frequency measurements or handover conditions based at least in part on the center frequency and SCS of the reference SSB for the serving cell being the same, respectively, as the center frequency and SCS of the reference SSB for the target cell, or using one or more inter-frequency measurements or handover conditions based at least in part on the center frequency and SCS of the reference SSB for the serving cell being different, respectively, than the center frequency and SCS of the reference SSB for the target cell.

Some aspects described herein relate to a method of wireless communication performed by a network node. The method may include transmitting configuration information that indicates one or more reference SSBs for a serving cell or one or more reference SSBs for a target cell. The method may include transmitting an indication to perform a handover from the serving cell to the target cell, the handover to be performed using one or more intra-frequency measurements or handover conditions based at least in part on a center frequency and SCS of a select reference SSB for the serving cell being the same, respectively, as a center frequency and SCS of a select reference SSB for the target cell, or using one or more inter-frequency measurements or handover conditions based at least in part on the center frequency and SCS of the select reference SSB for the serving cell being different, respectively, than the center frequency and SCS of the select reference SSB for the target cell.

Some aspects described herein relate to a method of wireless communication performed by a UE. The method may include identifying, for a radio resource control (RRC) re-establishment, whether a center frequency and SCS of a reference SSB for a serving cell are the same, respectively, as a center frequency and SCS of a reference SSB for a neighbor cell. The method may include initiating an RRC re-establishment using one or more intra-frequency measurements based at least in part on the center frequency and SCS of the reference SSB for the serving cell being the same, respectively, as the center frequency and SCS of the reference SSB for the neighbor cell, or using one or more inter-frequency measurements based at least in part on the center frequency and SCS of the reference SSB for the serving cell being different, respectively, than the center frequency and SCS of the reference SSB for the neighbor cell.

Some aspects described herein relate to a method of wireless communication performed by a network node. The method may include transmitting configuration information that indicates one or more reference SSBs for a serving cell or one or more reference SSBs for a neighbor cell. The method may include transmitting an indication to perform an RRC re-establishment, the RRC re-establishment to be performed using one or more intra-frequency measurements based at least in part on a center frequency and SCS of a select reference SSB for the serving cell being the same, respectively, as a center frequency and SCS of a select reference SSB for the neighbor cell, or using one or more inter-frequency measurements based at least in part on the center frequency and SCS of the select reference SSB for the serving cell being different, respectively, than the center frequency and SCS of the select reference SSB for the neighbor cell.

Some aspects described herein relate to a UE for wireless communication. The user equipment may include memory, one or more processors coupled to the memory, and instructions stored in the memory and executable by the one or more processors. The instructions may be executable by the one or more processors to cause the user equipment to identify, for a handover between a serving cell and a target cell, whether a center frequency and SCS of a reference SSB for the serving cell are the same, respectively, as a center frequency and SCS of a reference SSB for the target cell. The instructions may be executable by the one or more processors to cause the user equipment to initiate a handover from the serving cell to the target cell using one or more intra-frequency measurements or handover conditions based at least in part on the center frequency and SCS of the reference SSB for the serving cell being the same, respectively, as the center frequency and SCS of the reference SSB for the target cell, or using one or more inter-frequency measurements or handover conditions based at least in part on the center frequency and SCS of the reference SSB for the serving cell being different, respectively, than the center frequency and SCS of the reference SSB for the target cell.

Some aspects described herein relate to a network node for wireless communication. The network node may include memory, one or more processors coupled to the memory, and instructions stored in the memory and executable by the one or more processors. The instructions may be executable by the one or more processors to cause the network node to transmit configuration information that indicates one or more reference SSBs for a serving cell or one or more reference SSBs for a target cell. The instructions may be executable by the one or more processors to cause the network node to transmit an indication to perform a handover from the serving cell to the target cell, the handover to be performed using one or more intra-frequency measurements or handover conditions based at least in part on a center frequency and SCS of a select reference SSB for the serving cell being the same, respectively, as a center frequency and SCS of a select reference SSB for the target cell, or using one or more inter-frequency measurements or handover conditions based at least in part on the center frequency and SCS of the select reference SSB for the serving cell being different, respectively, than the center frequency and SCS of the select reference SSB for the target cell.

Some aspects described herein relate to a UE for wireless communication. The user equipment may include memory, one or more processors coupled to the memory, and instructions stored in the memory and executable by the one or more processors. The instructions may be executable by the one or more processors to cause the user equipment to identify, for an RRC re-establishment, whether a center frequency and SCS of a reference SSB for a serving cell are the same, respectively, as a center frequency and SCS of a reference SSB for a neighbor cell. The instructions may be executable by the one or more processors to cause the user equipment to initiate an RRC re-establishment using one or more intra-frequency measurements based at least in part on the center frequency and SCS of the reference SSB for the serving cell being the same, respectively, as the center frequency and SCS of the reference SSB for the neighbor cell, or using one or more inter-frequency measurements based at least in part on the center frequency and SCS of the reference SSB for the serving cell being different, respectively, than the center frequency and SCS of the reference SSB for the neighbor cell.

Some aspects described herein relate to a network node for wireless communication. The network node may include memory, one or more processors coupled to the memory, and instructions stored in the memory and executable by the one or more processors. The instructions may be executable by the one or more processors to cause the network node to transmit configuration information that indicates one or more reference SSBs for a serving cell or one or more reference SSBs for a neighbor cell. The instructions may be executable by the one or more processors to cause the network node to transmit an indication to perform an RRC re-establishment, the RRC re-establishment to be performed using one or more intra-frequency measurements based at least in part on a center frequency and SCS of a select reference SSB for the serving cell being the same, respectively, as a center frequency and SCS of a select reference SSB for the neighbor cell, or using one or more inter-frequency measurements based at least in part on the center frequency and SCS of the select reference SSB for the serving cell being different, respectively, than the center frequency and SCS of the select reference SSB for the neighbor cell.

Some aspects described herein relate to a non-transitory computer-readable medium that stores one or more instructions for wireless communication by a UE. The one or more instructions, when executed by one or more processors of the UE, may cause the UE to identify, for a handover between a serving cell and a target cell, whether a center frequency and SCS of a reference SSB for the serving cell are the same, respectively, as a center frequency and SCS of a reference SSB for the target cell. The one or more instructions, when executed by one or more processors of the UE, may cause the UE to initiate a handover from the serving cell to the target cell using one or more intra-frequency measurements or handover conditions based at least in part on the center frequency and SCS of the reference SSB for the serving cell being the same, respectively, as the center frequency and SCS of the reference SSB for the target cell, or using one or more inter-frequency measurements or handover conditions based at least in part on the center frequency and SCS of the reference SSB for the serving cell being different, respectively, than the center frequency and SCS of the reference SSB for the target cell.

Some aspects described herein relate to a non-transitory computer-readable medium that stores one or more instructions for wireless communication by a network node. The one or more instructions, when executed by one or more processors of the network node, may cause the network node to transmit configuration information that indicates one or more reference SSBs for a serving cell or one or more reference SSBs for a target cell. The one or more instructions, when executed by one or more processors of the network node, may cause the network node to transmit an indication to perform a handover from the serving cell to the target cell, the handover to be performed using one or more intra-frequency measurements or handover conditions based at least in part on a center frequency and SCS of a select reference SSB for the serving cell being the same, respectively, as a center frequency and SCS of a select reference SSB for the target cell, or using one or more inter-frequency measurements or handover conditions based at least in part on the center frequency and SCS of the select reference SSB for the serving cell being different, respectively, than the center frequency and SCS of the select reference SSB for the target cell.

Some aspects described herein relate to a non-transitory computer-readable medium that stores one or more instructions for wireless communication by a UE. The one or more instructions, when executed by one or more processors of the UE, may cause the UE to identify, for an RRC re-establishment, whether a center frequency and SCS of a reference SSB for a serving cell are the same, respectively, as a center frequency and SCS of a reference SSB for a neighbor cell. The one or more instructions, when executed by one or more processors of the UE, may cause the UE to initiate an RRC re-establishment using one or more intra-frequency measurements based at least in part on the center frequency and SCS of the reference SSB for the serving cell being the same, respectively, as the center frequency and SCS of the reference SSB for the neighbor cell, or using one or more inter-frequency measurements based at least in part on the center frequency and SCS of the reference SSB for the serving cell being different, respectively, than the center frequency and SCS of the reference SSB for the neighbor cell.

Some aspects described herein relate to a non-transitory computer-readable medium that stores one or more instructions for wireless communication by a network node. The one or more instructions, when executed by one or more processors of the network node, may cause the network node to transmit configuration information that indicates one or more reference SSBs for a serving cell or one or more reference SSBs for a neighbor cell. The one or more instructions, when executed by one or more processors of the network node, may cause the network node to transmit an indication to perform an RRC re-establishment, the RRC re-establishment to be performed using one or more intra-frequency measurements based at least in part on a center frequency and SCS of a select reference SSB for the serving cell being the same, respectively, as a center frequency and SCS of a select reference SSB for the neighbor cell, or using one or more inter-frequency measurements based at least in part on the center frequency and SCS of the select reference SSB for the serving cell being different, respectively, than the center frequency and SCS of the select reference SSB for the neighbor cell.

Some aspects described herein relate to an apparatus for wireless communication. The apparatus may include means for identifying, for a handover between a serving cell and a target cell, whether a center frequency and SCS of a reference SSB for the serving cell are the same, respectively, as a center frequency and SCS of a reference SSB for the target cell. The apparatus may include means for initiating a handover from the serving cell to the target cell using one or more intra-frequency measurements or handover conditions based at least in part on the center frequency and SCS of the reference SSB for the serving cell being the same, respectively, as the center frequency and SCS of the reference SSB for the target cell, or using one or more inter-frequency measurements or handover conditions based at least in part on the center frequency and SCS of the reference SSB for the serving cell being different, respectively, than the center frequency and SCS of the reference SSB for the target cell.

Some aspects described herein relate to an apparatus for wireless communication. The apparatus may include means for transmitting configuration information that indicates one or more reference SSBs for a serving cell or one or more reference SSBs for a target cell. The apparatus may include means for transmitting an indication to perform a handover from the serving cell to the target cell, the handover to be performed using one or more intra-frequency measurements or handover conditions based at least in part on a center frequency and SCS of a select reference SSB for the serving cell being the same, respectively, as a center frequency and SCS of a select reference SSB for the target cell, or using one or more inter-frequency measurements or handover conditions based at least in part on the center frequency and SCS of the select reference SSB for the serving cell being different, respectively, than the center frequency and SCS of the select reference SSB for the target cell.

Some aspects described herein relate to an apparatus for wireless communication. The apparatus may include means for identifying, for an RRC re-establishment, whether a center frequency and SCS of a reference SSB for a serving cell are the same, respectively, as a center frequency and SCS of a reference SSB for a neighbor cell. The apparatus may include means for initiating an RRC re-establishment using one or more intra-frequency measurements based at least in part on the center frequency and SCS of the reference SSB for the serving cell being the same, respectively, as the center frequency and SCS of the reference SSB for the neighbor cell, or using one or more inter-frequency measurements based at least in part on the center frequency and SCS of the reference SSB for the serving cell being different, respectively, than the center frequency and SCS of the reference SSB for the neighbor cell.

Some aspects described herein relate to an apparatus for wireless communication. The apparatus may include means for transmitting configuration information that indicates one or more reference SSBs for a serving cell or one or more reference SSBs for a neighbor cell. The apparatus may include means for transmitting an indication to perform an RRC re-establishment, the RRC re-establishment to be performed using one or more intra-frequency measurements based at least in part on a center frequency and SCS of a select reference SSB for the serving cell being the same, respectively, as a center frequency and SCS of a select reference SSB for the neighbor cell, or using one or more inter-frequency measurements based at least in part on the center frequency and SCS of the select reference SSB for the serving cell being different, respectively, than the center frequency and SCS of the select reference SSB for the neighbor cell.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a bandwidth part and synchronization signal block configuration, in accordance with the present disclosure.

FIG. 5 is a diagram illustrating an example of identifying a reference synchronization signal block for a UE handover, in accordance with the present disclosure.

FIG. 6 is a diagram illustrating an example of identifying a reference synchronization signal block for a radio resource control (RRC) re-establishment, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

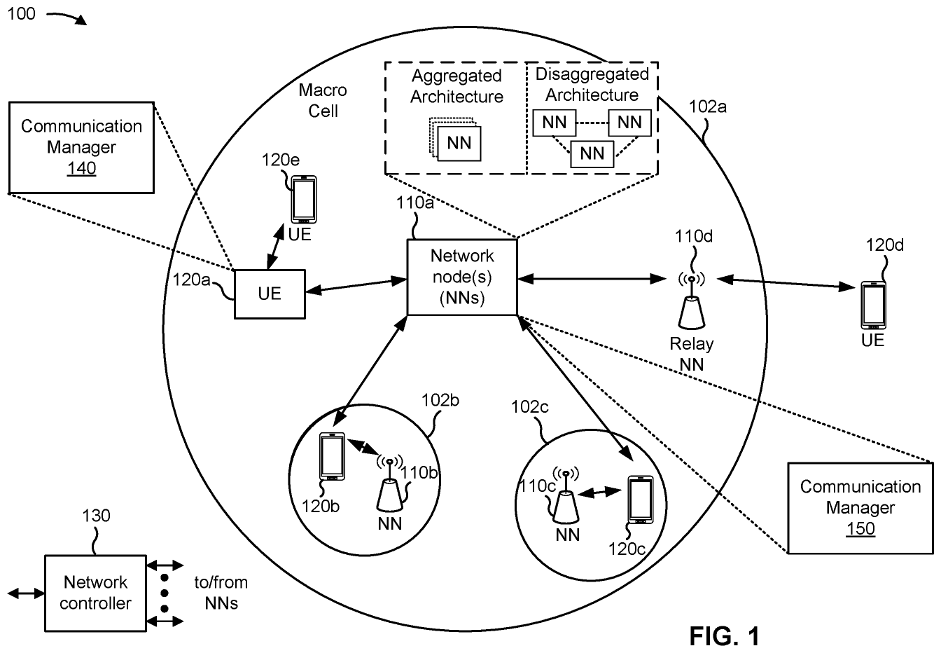

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system,

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHz), and FR5 (114.25 GHz-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may identify, for a handover between a serving cell and a target cell, whether a center frequency and sub-carrier spacing (SCS) of a reference synchronization signal block (SSB) for the serving cell are the same, respectively, as a center frequency and SCS of a reference SSB for the target cell; and initiate a handover from the serving cell to the target cell using one or more intra-frequency measurements or handover conditions based at least in part on the center frequency and SCS of the reference SSB for the serving cell being the same, respectively, as the center frequency and SCS of the reference SSB for the target cell, or using one or more inter-frequency measurements or handover conditions based at least in part on the center frequency and SCS of the reference SSB for the serving cell being different, respectively, than the center frequency and SCS of the reference SSB for the target cell. Additionally, or alternatively, the communication manager 140 may perform one or more other operations described herein.

In some aspects, the network node 110 may include a communication manager 150. As described in more detail elsewhere herein, the communication manager 150 may transmit configuration information that indicates one or more reference SSBs for a serving cell or one or more reference SSBs for a target cell; and transmit an indication to perform a handover from the serving cell to the target cell, the handover to be performed using one or more intra-frequency measurements or handover conditions based at least in part on a center frequency and SCS of a select reference SSB for the serving cell being the same, respectively, as a center frequency and SCS of a select reference SSB for the target cell, or using one or more inter-frequency measurements or handover conditions based at least in part on the center frequency and SCS of the select reference SSB for the serving cell being different, respectively, than the center frequency and SCS of the select reference SSB for the target cell. Additionally, or alternatively, the communication manager 150 may perform one or more other operations described herein.

In some aspects, the communication manager 140 may identify, for an RRC re-establishment, whether a center frequency and SCS of a reference SSB for a serving cell are the same, respectively, as a center frequency and SCS of a reference SSB for a neighbor cell; and initiate an RRC re-establishment using one or more intra-frequency measurements based at least in part on the center frequency and SCS of the reference SSB for the serving cell being the same, respectively, as the center frequency and SCS of the reference SSB for the neighbor cell, or using one or more inter-frequency measurements based at least in part on the center frequency and SCS of the reference SSB for the serving cell being different, respectively, than the center frequency and SCS of the reference SSB for the neighbor cell. Additionally, or alternatively, the communication manager 140 may perform one or more other operations described herein.

In some aspects, the communication manager 150 may transmit configuration information that indicates one or more reference SSBs for a serving cell or one or more reference SSBs for a neighbor cell; and transmit an indication to perform an RRC re-establishment, the RRC re-establishment to be performed using one or more intra-frequency measurements based at least in part on a center frequency and SCS of a select reference SSB for the serving cell being the same, respectively, as a center frequency and SCS of a select reference SSB for the neighbor cell, or using one or more inter-frequency measurements based at least in part on the center frequency and SCS of the select reference SSB for the serving cell being different, respectively, than the center frequency and SCS of the select reference SSB for the neighbor cell. Additionally, or alternatively, the communication manager 150 may perform one or more other operations described herein.

As indicated above, FIG. 1 is provided as an example. Other examples may differ from what is described with regard to FIG. 1.

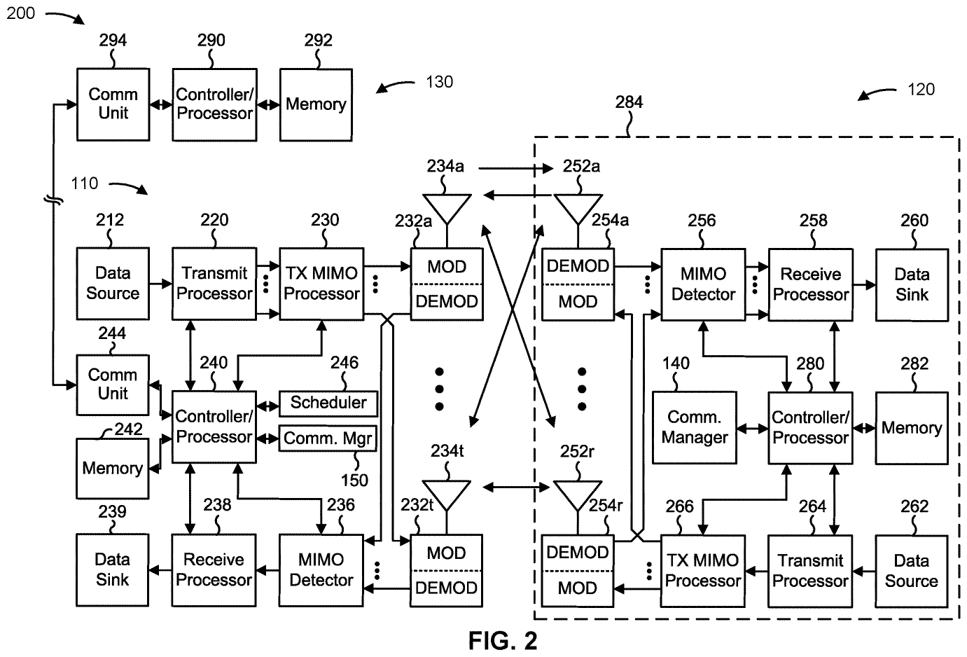

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

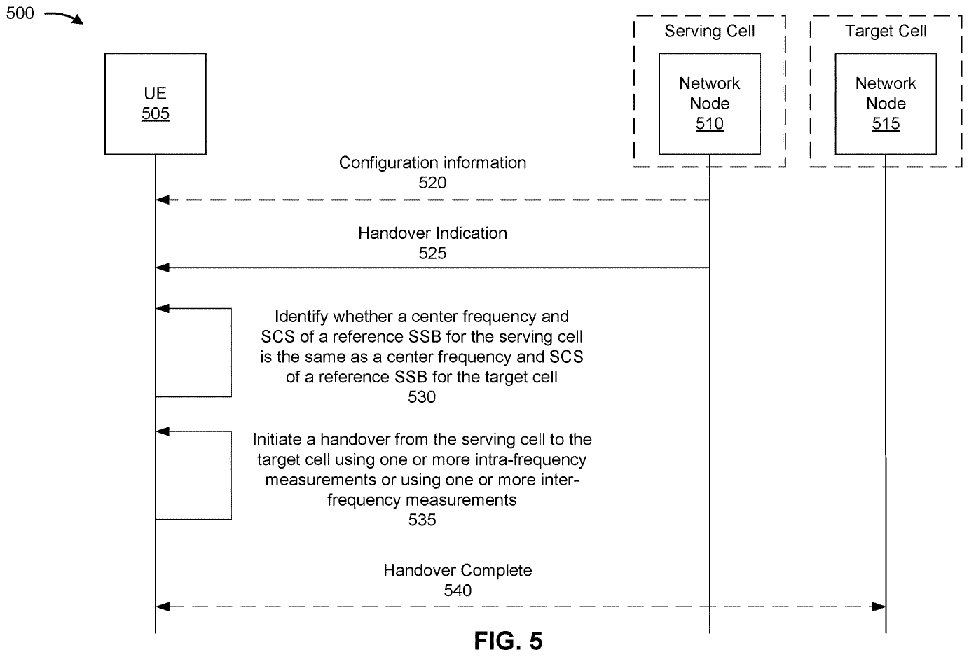

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-12).

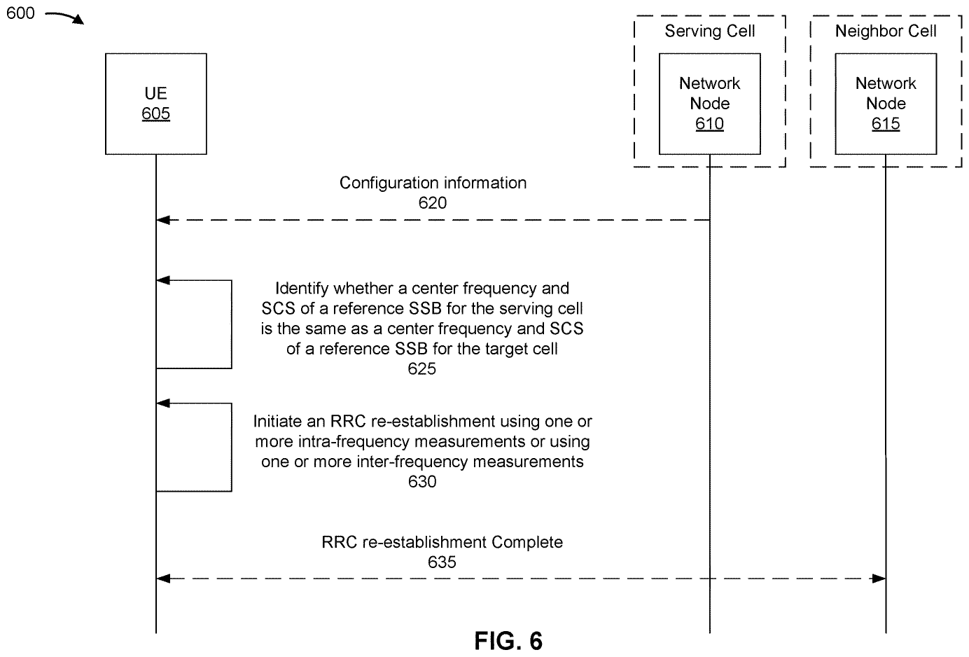

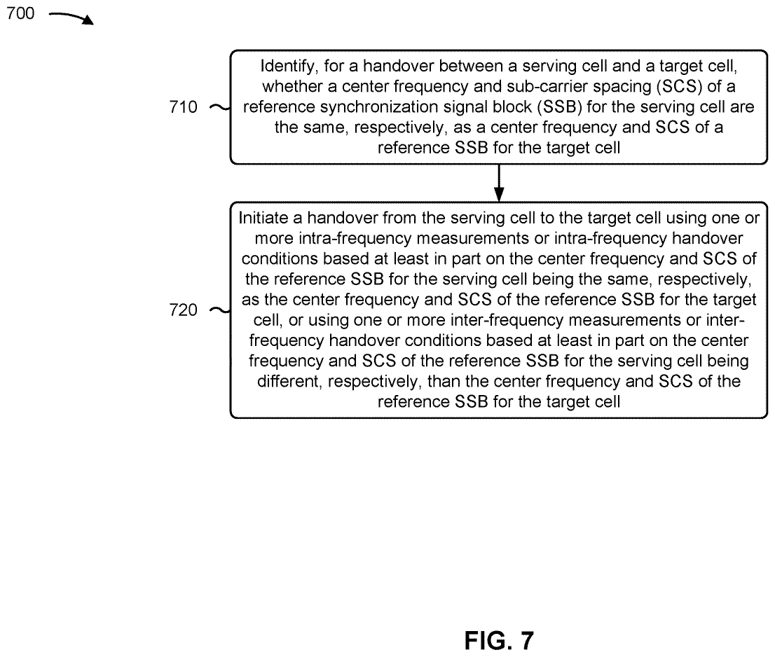

The controller/processor 240 of the network node 110, the controller/processor 280 of the UE 120, and/or any other component(s) of FIG. 2 may perform one or more techniques associated with a reference SSB for UE handover, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE includes means for identifying, for a handover between a serving cell and a target cell, whether a center frequency and SCS of a reference SSB for the serving cell are the same, respectively, as a center frequency and SCS of a reference SSB for the target cell; and/or means for initiating a handover from the serving cell to the target cell using one or more intra-frequency measurements or handover conditions based at least in part on the center frequency and SCS of the reference SSB for the serving cell being the same, respectively, as the center frequency and SCS of the reference SSB for the target cell, or using one or more inter-frequency measurements or handover conditions based at least in part on the center frequency and SCS of the reference SSB for the serving cell being different, respectively, than the center frequency and SCS of the reference SSB for the target cell. The means for the user equipment (UE) to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting configuration information that indicates one or more reference SSBs for a serving cell or one or more reference SSBs for a target cell; and/or means for transmitting an indication to perform a handover from the serving cell to the target cell, the handover to be performed using one or more intra-frequency measurements or handover conditions based at least in part on a center frequency and SCS of a select reference SSB for the serving cell being the same, respectively, as a center frequency and SCS of a select reference SSB for the target cell, or using one or more inter-frequency measurements or handover conditions based at least in part on the center frequency and SCS of the select reference SSB for the serving cell being different, respectively, than the center frequency and SCS of the select reference SSB for the target cell. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE includes means for identifying, for an RRC re-establishment, whether a center frequency and SCS of a reference SSB for a serving cell are the same, respectively, as a center frequency and SCS of a reference SSB for a neighbor cell; and/or means for initiating an RRC re-establishment using one or more intra-frequency measurements based at least in part on the center frequency and SCS of the reference SSB for the serving cell being the same, respectively, as the center frequency and SCS of the reference SSB for the neighbor cell, or using one or more inter-frequency measurements based at least in part on the center frequency and SCS of the reference SSB for the serving cell being different, respectively, than the center frequency and SCS of the reference SSB for the neighbor cell. The means for the user equipment (UE) to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting configuration information that indicates one or more reference SSBs for a serving cell or one or more reference SSBs for a neighbor cell; and/or means for transmitting an indication to perform an RRC re-establishment, the RRC re-establishment to be performed using one or more intra-frequency measurements based at least in part on a center frequency and SCS of a select reference SSB for the serving cell being the same, respectively, as a center frequency and SCS of a select reference SSB for the neighbor cell, or using one or more inter-frequency measurements based at least in part on the center frequency and SCS of the select reference SSB for the serving cell being different, respectively, than the center frequency and SCS of the select reference SSB for the neighbor cell. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

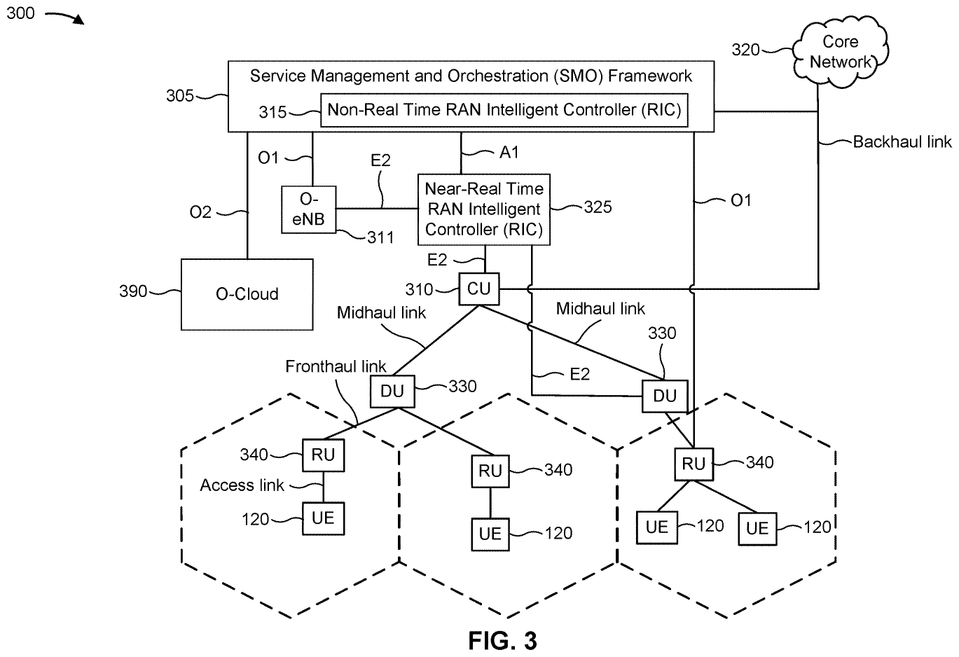

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

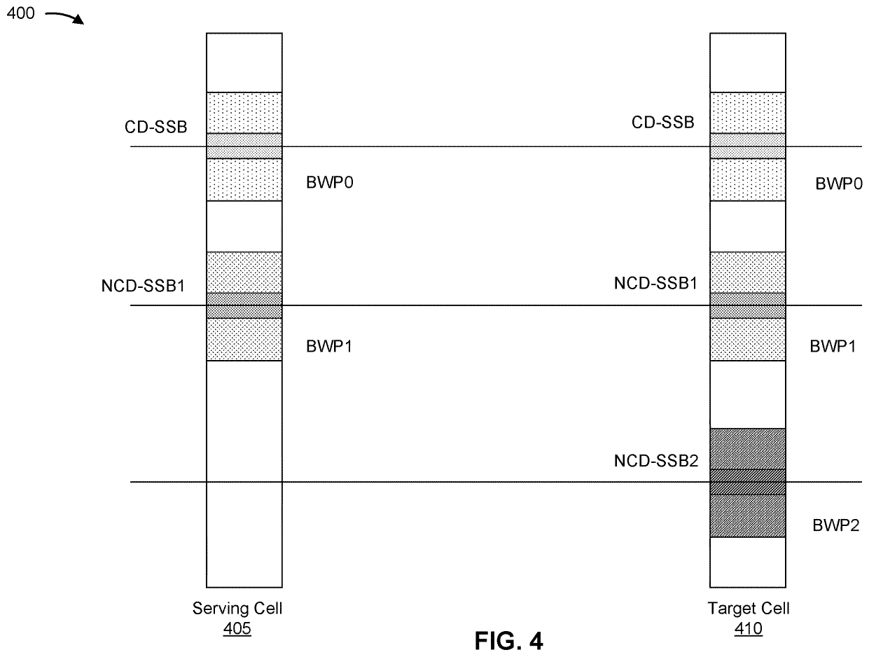

FIG. 4 is a diagram illustrating an example 400 of a bandwidth part and synchronization signal block configuration, in accordance with the present disclosure. A UE may perform a handover from a serving cell 405 to a target cell 410. The handover may be performed, for example, based at least in part on a movement of the UE from a coverage area of the serving cell 405 to a coverage area of the target cell 410 and/or based at least in part on reference signal measurements associated with the serving cell 405 and the target cell 410. The handover may be from an NR Primary Cell (PCell) to another NR Cell, such as another NR PCell or an NR secondary cell (SCell).

In some cases, the UE may receive a radio resource control (RRC) message from the serving cell 405 and/or the target cell 410 that indicates for the UE to perform the handover. The UE may need to be ready to start an uplink physical random access channel (PRACH) transmission within D_{handover} milliseconds (ms) from an end of a last transmission time interval (TTI) containing the RRC command. In some cases, D_{handover} may be equal to an applicable RRC procedure delay (e.g., as defined in Technical Specification (TS) 38.331, Clause 12 of the 3GPP Specification) plus an interruption time Tᵢₙₜₑᵣᵣᵤₚₜ, where Tᵢₙₜₑᵣᵣᵤₚₜ is defined as follows:

$${T}_{interrupt} = {T}_{search} + {T}_{IU} + {T}_{processing} + {T}_{Δ} + {T}_{margin} ms ,$$

where
T_{search} is a time required for the UE to search the target cell when it is not known when the handover command is received by the UE;
T_{IU} is an interruption uncertainty in acquiring the first available PRACH occasion in the target cell;
T_{processing} is a processing time associated with the UE;
T_{Δ} is a time for fine time tracking and acquiring full timing information of the target cell; and
T_{margin} is a time for SSB post-processing.

In some cases, T_{search} may depend on whether the handover is an intra-frequency handover or an inter-frequency handover. A handover may be classified as an intra-frequency handover if the center frequency of the SSB for the serving cell and the center frequency of the SSB for the neighbor cell (e.g., target cell) are the same, and the SCS of the SSB for the serving cell and the SCS of the SSB for the neighbor cell are also the same. For a RedCap UE, if the target cell is known, then T_{search}=0 ms. If the target cell is an unknown intra-frequency cell and the target cell Es/lot≥−2 dB, then T_{search}=2*Tᵣₛ ms. If the target cell is an unknown inter-frequency cell and the target cell Es/lot≥−2 dB, then T_{search}=5*Tᵣₛ ms. In some cases, Tᵣₛ may be the synchronization signal block measurement timing configuration (SMTC) configured in the measObjectNR having the same SSB frequency and SCS as the non-cell defining (NCD)-SSB indicated by nonCellDefiningSSB-r17 if the first active DL bandwidth-part (BWP) included in handover command is configured with nonCellDefiningSSB-r17, otherwise, as cell-defining (CD)-SSB indicated by absoluteFrequencySSB in frequencyInfoDL in the handover command.

In some cases, classification of the handover from the serving cell 405 to the target cell 410 as intra-frequency or inter-frequency may depend on whether the SSB of target cell 410 is measured as an intra-frequency or inter-frequency measurement object.

In some cases, the UE may be a reduced capabilities (RedCap) UE. A RedCap UE is a UE that has a reduced or limited set of features or capabilities, such as a subset of the features and capabilities described above in connection with the UE 120. The RedCap UE (e.g., as defined by feature 28-1 in the 3GPP specifications) may have one or more of the features indicated in Table 1:

TABLE 1

| | | | | Pre- | |
|---|---|---|---|---|---|
| | | | | requisite | |
| Feature | Feature | | | Feature | Mandatory/ |
| # | Title | Feature Description | | Groups | Optional |
| 28-1 | RedCap | 1. | Maximum frequency range 1 | — | Optional with |
| | UE | | (FR1) RedCap UE bandwidth is 20 | | capability |
| | | | MHz. | | signaling. |
| | | 2. | Maximum frequency range 2 | | RedCap UE |
| | | | (FR2) RedCap UE Bandwidth is | | may need to |
| | | | 100 MHz. | | indicate that |
| | | 3. | Early indication of RedCap UE in | | this feature |
| | | | Msg. 1 for 4-step random access | | group is |
| | | | channel (RACH). | | supported. |
| | | 4. | Separate initial uplink (UL) | | |
| | | | bandwidth part (BWP) for RedCap | | |
| | | | UEs. | | |
| | | | Includes the configuration(s) | | |
| | | | needed for RedCap UE to perform | | |
| | | | random access. | | |
| | | | Enabling/disabling of frequency | | |
| | | | hopping for common physical | | |
| | | | uplink control channel (PUCCH) | | |
| | | | resources. | | |
| | | 5. | Separate initial downlink (DL) | | |
| | | | BWP for RedCap UEs. | | |
| | | | Includes common search space | | |
| | | | (CSS) and control resource set | | |
| | | | (CORESET) for random access. | | |
| | | | For separate initial DL BWP used | | |
| | | | for paging, cell defining SSB (CD- | | |
| | | | SSB) is included. | | |
| | | | For separate initial DL BWP only | | |
| | | | used for RACH, SSB may or may | | |
| | | | not be included. | | |
| | | | For separate initial DL BWP used | | |
| | | | in connection mode as BWP#0 | | |
| | | | configuration option 1, CD-SSB is | | |
| | | | included. | | |
| | | 6. | One UE-specific RRC configured | | |
| | | | DL BWP per carrier. | | |
| | | 7. | One UE-specific RRC configured | | |
| | | | UL BWP per carrier. | | |
| | | 8. | RRC reconfiguration of any | | |
| | | | parameters related to BWP. | | |
| | | 9. | UE-Specific RRC configured DL | | |
| | | | BWP with CD-SSB or non-cell | | |
| | | | defining SSB (NCD-SSB). | | |
| | | 10. | NCD-SSB based measurements in | | |
| | | | RRC-configured DL BWP. | | |
| 28-1a | RRC- | | RRC configured DL BWP without | 28-1 | Optional with |
| | configured | | CD-SSB or NCD-SSB. | | capability |
| | DL BWP | | | | signaling |
| | without | | | | |
| | CD-SSB or | | | | |
| | NCD-SSB | | | | |

In some cases, for a RedCap UE, more than one SSB may be indicated as the SSB of the serving cell. RAN2 defines which SSB is to be used as the reference SSB for defining intra-frequency and inter-frequency measurements. In some cases, a BWP-specific serving cell measurement object (MO) (servingCellMO) may be defined under BWP-DownlinkDedicated, and the SSB indicated in the servingCellMO is the reference SSB to be used for the serving cell measurements when the UE is in this active BWP. If this indication is absent, the SSB defined in the servingCellMO under ServingCellConfig is the reference SSB to be used for serving cell measurements. This reference SSB may be used to define intra-frequency measurements. In some cases, a RedCap UE can be handed over to a BWP that contains an NCD-SSB but not a CD-SSB.

In a handover procedure for non-RedCap UEs (e.g., a legacy handover), a single SSB (e.g., a CD-SSB) may be present in the target cell. This SSB may be specified as the servingCellMO of the target cell and may be used for cell search and measurements of the target cell during and after the handover procedure. This SSB may also be present in the firstActiveBWP of the target cell and may be configured as the targetCellMO of the serving cell.

In some cases, a RedCap UE may be configured with multiple SSBs in the serving cell and/or in the target cell. For example, the RedCap UE may be configured with a CD-SSB and one or more NCD-SSBs in the serving cell, and/or may be configured with a CD-SSB and one or more NCD-SSBs in the target cell. The RedCap UE (and/or the network node) may not be able to determine which SSB of the target cell is to be used for classifying the handover as an intra-frequency handover or an inter-frequency handover. For example, the RedCap UE may not be able to determine whether to use the SSB configured in the targetCellMO of the serving cell, the SSB configured in the firstActiveBWP of the target cell, or the SSB configured in the servingCellMO of the target cell as the reference SSB for the target cell. Additionally, or alternatively, the RedCap UE (and/or the network node) may not be able to determine which SSB of the serving cell is to be used for classifying the handover as an intra-frequency handover or an inter-frequency handover. For example, the RedCap UE may not be able to determine whether to use the SSB configured within the active BWP, the SSB defined in the servingCellMO, or the BWP-specific servingCellMO (if defined) as the reference SSB for the serving cell. Thus, the UE (and/or the network node) may not be able to accurately determine the timing information, such as the time for searching the target cell, for performing the handover from the serving cell to the target cell

Techniques and apparatuses are described herein for a reference SSB for UE handover, in accordance with the present disclosure. A UE may identify, for a handover between a serving cell and a target cell, whether a center frequency and SCS of a reference SSB for the serving cell are the same, respectively, as a center frequency and SCS of a reference SSB for the target cell. The UE may initiate a handover from the serving cell to the target cell using one or more intra-frequency measurements and/or handover conditions based at least in part on the center frequency and SCS of the reference SSB for the serving cell being the same, respectively, as the center frequency and SCS of the reference SSB for the target cell. Alternatively, the UE may initiate a handover from the serving cell to the target cell using one or more inter-frequency measurements and/or handover conditions based at least in part on the center frequency and SCS of the reference SSB for the serving cell being different, respectively, than the center frequency and SCS of the reference SSB for the target cell. The reference SSB for the serving cell may correspond, for example, to an SSB configured in a serving cell measurement object, an SSB configured in a bandwidth part-specific serving cell measurement object, or an SSB configured in an active bandwidth part of the serving cell. The reference SSB for the target cell may correspond, for example, to an SSB configured in a first active bandwidth part of the target cell, an SSB configured in a serving cell measurement object of the target cell, an SSB configured in a bandwidth part-specific serving cell measurement object of the target cell, or an SSB configured in a target cell measurement object of the serving cell. This may enable the UE (and/or the network node) to determine the timing information, such as the time for searching the target cell, for performing the handover from the serving cell to the target cell. Additional details are described herein.

As indicated above, FIG. 4 is provided as an example. Other examples may differ from what is described with regard to FIG. 4.

FIG. 5 is a diagram illustrating an example 500 of identifying a reference SSB for a UE handover, in accordance with the present disclosure. A UE 505 may communicate with a network node 510 and a network node 515. For example, the network node 510 may be associated with a serving cell, the network node 515 may be associated with a target cell, and the UE 505 may communicate with the network node 510 and the network node 515 while performing a handover from serving cell to the target cell. In some aspects, the UE 505 may be a RedCap UE.

As shown by reference number 520, the network node 510 may transmit, and the UE 505 may receive, configuration information. The configuration information may indicate a reference SSB for the serving cell and/or a reference SSB for the target cell. In some aspects, the configuration information may indicate two or more reference SSBs for the serving cell. For example, the configuration information may indicate a CD-SSB for the serving cell and one or more NCD-SSBs for the serving cell. Additionally, or alternatively, the configuration information may indicate two or more reference SSBs for the target cell. For example, the configuration information may indicate a CD-SSB for the target cell and one or more NCD-SSBs for the target cell. The configuration information may be indicated, for example, via sidelink control information (SCI), a medium access control (MAC) control element (CE) (MAC-CE), a radio resource control (RRC) message, system information, and/or in the handover command, among other examples. In some aspects, the configuration information may be indicated in a specification, such as the 3GPP specification.

In some aspects, the UE 505 may be configured (e.g., pre-configured) with the configuration information and/or may receive the configuration information from another device or network node. In this case, the UE 505 may not receive the configuration information from the network node 510.

As shown by reference number 525, the network node 510 may transmit, and the UE 505 may receive, a handover indication. The handover indication may indicate for the UE 505 to perform a handover from the serving cell (and/or the network node 510) to the target cell (and/or the network node 515).

As shown by reference number 530, the UE 505 may identify whether a center frequency and SCS of the reference SSB for the serving cell are the same, respectively, as a center frequency and SCS of the reference SSB for the target cell. In some aspects, the reference SSB for the serving cell may correspond, for example, to an SSB configured in a serving cell measurement object (servingCellMO), an SSB configured in a bandwidth part-specific serving cell measurement object (BWP-specific servingCellMO), or an SSB configured in an active bandwidth part of the serving cell, among other examples. The reference SSB for the target cell may correspond, for example, to an SSB configured in a first active bandwidth part (firstActiveBWP) of the target cell, an SSB configured in a serving cell measurement object (servingCelIMO) of the target cell, an SSB configured in a bandwidth part-specific serving cell measurement object (BWP-specific servingCellMO) of the target cell, or an SSB configured in a target cell measurement object (targetCellMO) of the serving cell, among other examples.

In some aspects, the reference SSB for the serving cell may correspond to the SSB configured in the servingCellMO (or the BWP-specific servingCellMO, if configured) of the serving cell, and the reference SSB for the target cell may correspond to the SSB configured in the firstActiveBWP of the target cell. In this case, the handover may be classified as an intra-frequency handover (“intra”) or an inter-frequency handover (“inter”) as shown in Table 2.

TABLE 2

| | | | | | |
|---|---|---|---|---|---|
| | Serving | | Target | Target | |
| Serving | Cell | Target | Cell | cell | |
| Cell | Active | Cell | firstActive- | servingCell- | Handover |
| MO | BWP | MO | BWP | MO | Type |

| | | | |
|---|---|---|---|
| CD-SSB | BWP0 | BWP0 | Intra |
| CD-SSB | BWP1 | BWP0 | Intra |
| NCD-SSB1 | BWP1 | BWP0 | Inter |
| CD-SSB | BWP0 | BWP1 | Inter |
| CD-SSB | BWP1 | BWP1 | Inter |
| NCD-SSB1 | BWP1 | BWP1 | Intra |

In some aspects, the reference SSB for the serving cell may correspond to the SSB configured in the servingCellMO (or the BWP-specific servingCellMO, if configured) of the serving cell, and the reference SSB for the target cell may correspond to the SSB configured in the servingCellMO (or the BWP-specific servingCellMO, if configured) of the target cell. In this case, the handover may be considered to be an intra-frequency handover or an inter-frequency handover as shown in Table 3.

TABLE 3

| | | | | | |
|---|---|---|---|---|---|
| | Serving | | Target | Target | |
| Serving | Cell | Target | Cell | cell | |
| Cell | Active | Cell | firstActive- | servingCell- | Handover |
| MO | BWP | MO | BWP | MO | Type |

| | | | | |
|---|---|---|---|---|
| CD-SSB | BWP0 | BWP0 | CD-SSB | Intra |
| CD-SSB | BWP1 | BWP0 | CD-SSB | Intra |
| NCD-SSB1 | BWP1 | BWP0 | CD-SSB | Inter |
| CD-SSB | BWP0 | BWP1 | NCD-SSB1 | Inter |
| CD-SSB | BWP1 | BWP1 | NCD-SSB1 | Inter |
| NCD-SSB1 | BWP1 | BWP1 | NCD-SSB1 | Intra |
| CD-SSB | BWP0 | BWP1 | CD-SSB | Intra |
| CD-SSB | BWP1 | BWP1 | CD-SSB | Intra |
| NCD-SSB1 | BWP1 | BWP1 | CD-SSB | Inter |

As shown by reference number 535, the UE 505 may initiate a handover from the serving cell to the target cell using one or more intra-frequency measurements and/or handover conditions based at least in part on the center frequency and SCS of the reference SSB for the serving cell being the same, respectively, as the center frequency and SCS of the reference SSB for the target cell. Alternatively, the UE 505 may initiate a handover from the serving cell to the target cell using one or more inter-frequency measurements and/or handover conditions based at least in part on the center frequency and SCS of the reference SSB for the serving cell being different, respectively, than the center frequency and SCS of the reference SSB for the target cell. The one or more intra-frequency measurements may correspond, for example, to a first search time (e.g., T_{search}=Tᵣₛ ms) for searching the target cell. Alternatively, the one or more inter-frequency measurements may correspond, for example, to a second search time (e.g., T_{search}=3*Tᵣₛ ms) for searching the target cell.

In some aspects, the UE 505 may receive an indication of a priority for selecting the reference SSB from a plurality of SSBs. For example, the reference SSB for the serving cell may correspond to the SSB in the active BWP of the serving cell or to the SSB in the servingCellMO of the serving cell. The priority information may indicate to use the SSB that corresponds to the SSB in the active BWP of the serving cell, if configured, and otherwise, to use the SSB that corresponds to the SSB in the servingCellMO of the serving cell. The priority information may be indicated, for example, via sidelink control information (SCI), a medium access control (MAC) control element (CE) (MAC-CE), a radio resource control (RRC) message, system information, and/or in the handover command, among other examples. In some aspects, the priority information may be indicated in a specification, such as the 3GPP specification. In some aspects, the priority information may indicate an order for selecting the reference SSB from a plurality of reference SSBs.

In some aspects, the UE 505 may select the reference SSB from a plurality of SSBs based at least in part on UE capability information. For example, the UE 505 may be configured with a CD-SSB or an NCD-SSB in the active BWP. The UE 505 may select the SSB in the active BWP to be the reference SSB of the serving cell. In some aspects, the UE 505 (e.g., a 28-1a UE, as described in Table 1) may not be guaranteed to have any SSB in the active BWP. Thus, the UE 505 may select the SSB corresponding to the SSB in the servingCellMO of the serving cell as the reference SSB (e.g., even if the active BWP of the UE 505 contains an SSB). The type of the UE 505 (e.g., whether the UE is a 28-1 UE or a 28-1a UE) may impact the selection of the reference SSB of the target cell after the handover is complete. Additionally, or alternatively, the type of UE may impact the reference SSB of the serving cell.

As shown by reference number 540, the UE 505 and the network node 515 may communicate a handover complete message. Additionally, the UE 505 and the network node 515 may communicate other information after the completion of the handover.

As indicated above, FIG. 5 is provided as an example. Other examples may differ from what is described with regard to FIG. 5.

An RRC connection re-establishment may be initiated when a UE in an RRC_CONNECTED state loses RRC connection due to one or more failure cases, such as a radio link failure, a handover failure, or an RRC connection reconfiguration failure. In the RRC_CONNECTED state, the UE may be capable of sending an RRCRe-establishmentRequest message within T_{re-establish_delay} seconds from when the UE detects a loss in RRC connection. The total RRC connection delay (T_{re-establish_delay}) may be less than:

$${T}_{re - establish \_ delay} = {T}_{UE \_ re - establish \_ delay} + {T}_{UL \_ grant} ,$$

T_{UL_grant} is the time required to acquire and process an uplink grant from a neighbor PCell. The uplink grant may be required to transmit the RRCRe-establishmentRequest message.

FIG. 6 is a diagram illustrating an example 600 of identifying a reference SSB for an RRC re-establishment, in accordance with the present disclosure. A UE 605 may communicate with a network node 610 and a network node 615. The network node 610 may be associated with a serving cell and the network node 615 may be associated with a neighbor cell. In some aspects, the UE 605 may be a RedCap UE.

As shown by reference number 620, the network node 610 may transmit, and the UE 605 may receive, configuration information. The configuration information may indicate a reference SSB for the serving cell and/or a reference SSB for the neighbor cell. In some aspects, the configuration information may indicate two or more reference SSBs for the serving cell. For example, the configuration information may indicate a CD-SSB for the serving cell and one or more NCD-SSBs for the serving cell. Additionally, or alternatively, the configuration information may indicate two or more reference SSBs for the neighbor cell. For example, the configuration information may indicate a CD-SSB for the neighbor cell and one or more NCD-SSBs for the neighbor cell. The configuration information may be indicated, for example, via sidelink control information (SCI), a medium access control (MAC) control element (CE) (MAC-CE), a radio resource control (RRC) message, and/or system information, among other examples. In some aspects, the configuration information may be indicated in a specification, such as the 3GPP specification.

As shown by reference number 625, the UE 605 may identify whether a center frequency and SCS of the reference SSB for the serving cell are the same, respectively, as a center frequency and SCS of the reference SSB for the neighbor cell. In some aspects, the reference SSB for the serving cell may correspond to a cell-defining SSB of the serving cell, an SSB configured in an active bandwidth part of the serving cell, an SSB configured in a serving cell measurement object (servingCellMO), or a bandwidth-part-specific serving cell measurement object (BWP-specific servingCellMO), if configured, among other examples. The reference SSB for the neighbor cell may corresponds to a cell-defining SSB, a non-cell-defining SSB of one or more non-cell-defining SSBs, if configured, or an SSB configured in a measurement object for the neighbor cell, among other examples.

As shown by reference number 630, the UE 605 may initiate the RRC re-establishment using one or more intra-frequency measurements based at least in part on the center frequency and SCS of the reference SSB for the serving cell being the same, respectively, as the center frequency and SCS of the reference SSB for the neighbor cell. Alternatively, the UE 605 may initiate the RRC re-establishment using one or more inter-frequency measurements based at least in part on the center frequency and SCS of the reference SSB for the serving cell being different, respectively, than the center frequency and SCS of the reference SSB for the neighbor cell.

In some aspects, the UE 605 may receive an indication of a priority for selecting the reference SSB from a plurality of SSBs. For example, the reference SSB for the serving cell may correspond to the SSB in the active BWP of the serving cell or to the SSB in the servingCellMO of the serving cell. The priority information may indicate to use the SSB that corresponds to the SSB in the active BWP of the serving cell, if configured, and otherwise, to use the SSB that corresponds to the SSB in the servingCellMO of the serving cell. The priority information may be indicated, for example, via sidelink control information (SCI), a medium access control (MAC) control element (CE) (MAC-CE), a radio resource control (RRC) message, system information, and/or in the RRC re-establishment command, among other examples. In some aspects, the priority information may be indicated in a specification, such as the 3GPP specification. In some aspects, the priority information may indicate an order for selecting the reference SSB from a plurality of reference SSBs.

In some aspects, the UE 605 may select the reference SSB from a plurality of SSBs based at least in part on UE capability information. For example, the UE 605 may be configured with a CD-SSB or an NCD-SSB in the active BWP. The UE 605 may select the SSB in the active BWP to be the reference SSB of the serving cell. In some aspects, the UE 605 (e.g., a 28-1a UE, as described in Table 1) may not be guaranteed to have any SSB in the active BWP. Thus, the UE 605 may select the SSB corresponding to the SSB in the servingCellMO of the serving cell as the reference SSB (e.g., even if the active BWP of the UE 605 contains an SSB). The type of the UE 605 (e.g., whether the UE is a 28-1 UE or a 28-1a UE) may impact the selection of the reference SSB of the neighbor cell after the RRC re-establishment is complete. Additionally, or alternatively, the type of UE may impact the reference SSB of the serving cell.

As shown by reference number 635, the UE 605 and the network node 615 may communicate an RRC re-establishment complete message.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with identifying a reference SSB.

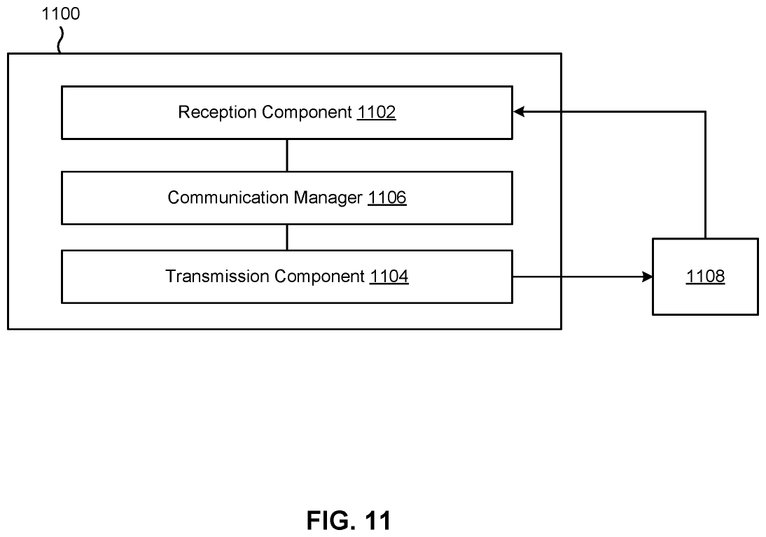

As shown in FIG. 7, in some aspects, process 700 may include identifying, for a handover between a serving cell and a target cell, whether a center frequency and sub-carrier spacing (SCS) of a reference synchronization signal block (SSB) for the serving cell are the same, respectively, as a center frequency and SCS of a reference SSB for the target cell (block 710). For example, the UE (e.g., using communication manager 1106, depicted in FIG. 11) may identify, for a handover between a serving cell and a target cell, whether a center frequency and sub-carrier spacing (SCS) of a reference synchronization signal block (SSB) for the serving cell are the same, respectively, as a center frequency and SCS of a reference SSB for the target cell, as described above.

As further shown in FIG. 7, in some aspects, process 700 may include initiating a handover from the serving cell to the target cell using one or more intra-frequency measurements or handover conditions based at least in part on the center frequency and SCS of the reference SSB for the serving cell being the same, respectively, as the center frequency and SCS of the reference SSB for the target cell, or using one or more inter-frequency measurements or handover conditions based at least in part on the center frequency and SCS of the reference SSB for the serving cell being different, respectively, than the center frequency and SCS of the reference SSB for the target cell (block 720). For example, the UE (e.g., using communication manager 1106, depicted in FIG. 11) may initiate a handover from the serving cell to the target cell using one or more intra-frequency measurements or handover conditions based at least in part on the center frequency and SCS of the reference SSB for the serving cell being the same, respectively, as the center frequency and SCS of the reference SSB for the target cell, or using one or more inter-frequency measurements or handover conditions based at least in part on the center frequency and SCS of the reference SSB for the serving cell being different, respectively, than the center frequency and SCS of the reference SSB for the target cell, as described above,

Process 700 may include additional aspects, such as any single aspect or any combination of aspects described below and/or in connection with one or more other processes described elsewhere herein.

In a first aspect, the UE is a reduced capabilities UE.

In a second aspect, alone or in combination with the first aspect, the UE is configured with at least two SSBs for the serving cell or at least two SSBs for the target cell.

In a third aspect, alone or in combination with one or more of the first and second aspects, the at least two SSBs for the serving cell include a cell-defining SSB and one or more non-cell-defining SSBs, and the at least two SSBs for the target cell include a cell-defining SSB and one or more non-cell-defining SSBs.

In a fourth aspect, alone or in combination with one or more of the first through third aspects, the reference SSB for the serving cell corresponds to an SSB configured in a serving cell measurement object, an SSB configured in a bandwidth-part-specific serving cell measurement object, if configured, or an SSB configured in an active bandwidth part of the serving cell.

In a fifth aspect, alone or in combination with one or more of the first through fourth aspects, the reference SSB for the target cell corresponds to an SSB configured in a first active bandwidth part of the target cell, an SSB configured in a serving cell measurement object of the target cell, an SSB configured in a bandwidth-part-specific serving cell measurement object of the target cell, if configured, or an SSB configured in a target cell measurement object of the serving cell.

In a sixth aspect, alone or in combination with one or more of the first through fifth aspects, process 700 includes receiving priority information for selecting the reference SSB for the serving cell from a plurality of SSBs for the serving cell, or for selecting the reference SSB for the target cell from a plurality of SSBs for the target cell.

In a seventh aspect, alone or in combination with one or more of the first through sixth aspects, receiving the priority information comprises receiving downlink control information, a medium access control message, a radio resource control message, system information, or a handover command that includes the priority information.

In an eighth aspect, alone or in combination with one or more of the first through seventh aspects, process 700 includes selecting, based at least in part on UE capability information, the reference SSB for the serving cell from a plurality of SSBs for the serving cell, or the reference SSB for the target cell from a plurality of SSBs for the target cell.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

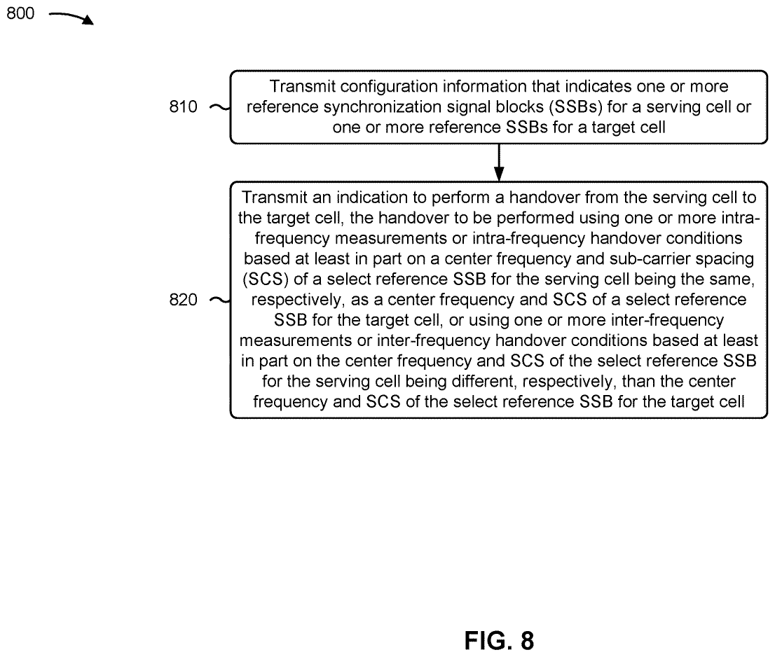

FIG. 8 is a diagram illustrating an example process 800 performed, for example, by a network node, in accordance with the present disclosure. Example process 800 is an example where the network node (e.g., network node 110) performs operations associated with identifying a reference SSB.

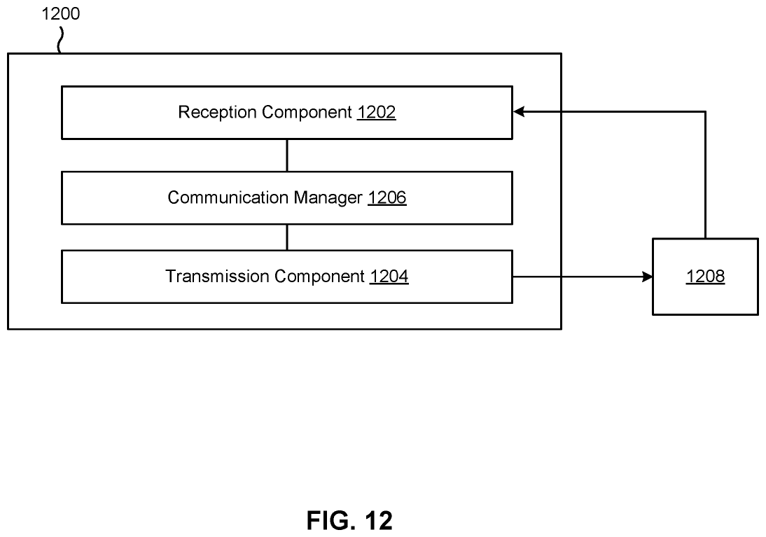

As shown in FIG. 8, in some aspects, process 800 may include transmitting configuration information that indicates one or more reference synchronization signal blocks (SSBs) for a serving cell or one or more reference SSBs for a target cell (block 810). For example, the network node (e.g., using transmission component 1204 and/or communication manager 1206, depicted in FIG. 12) may transmit configuration information that indicates one or more reference synchronization signal blocks (SSBs) for a serving cell or one or more reference SSBs for a target cell, as described above.

As further shown in FIG. 8, in some aspects, process 800 may include transmitting an indication to perform a handover from the serving cell to the target cell, the handover to be performed using one or more intra-frequency measurements or handover conditions based at least in part on a center frequency and sub-carrier spacing (SCS) of a select reference SSB for the serving cell being the same, respectively, as a center frequency and SCS of a select reference SSB for the target cell, or using one or more inter-frequency measurements or handover conditions based at least in part on the center frequency and SCS of the select reference SSB for the serving cell being different, respectively, than the center frequency and SCS of the select reference SSB for the target cell (block 820). For example, the network node (e.g., using transmission component 1204 and/or communication manager 1206, depicted in FIG. 12) may transmit an indication to perform a handover from the serving cell to the target cell, the handover to be performed using one or more intra-frequency measurements or handover conditions based at least in part on a center frequency and sub-carrier spacing (SCS) of a select reference SSB for the serving cell being the same, respectively, as a center frequency and SCS of a select reference SSB for the target cell, or using one or more inter-frequency measurements or handover conditions based at least in part on the center frequency and SCS of the select reference SSB for the serving cell being different, respectively, than the center frequency and SCS of the select reference SSB for the target cell, as described above.

Process 800 may include additional aspects, such as any single aspect or any combination of aspects described below and/or in connection with one or more other processes described elsewhere herein.

In a first aspect, the one or more reference SSBs for the serving cell include a cell-defining SSB and one or more non-cell-defining SSBs, and the one or more reference SSBs for the target cell include a cell-defining SSB and one or more non-cell-defining SSBs.

In a second aspect, alone or in combination with the first aspect, the select reference SSB for the serving cell corresponds to an SSB configured in a serving cell measurement object, an SSB configured in a bandwidth-part-specific serving cell measurement object, if configured, or an SSB configured in an active bandwidth part of the serving cell.

In a third aspect, alone or in combination with one or more of the first and second aspects, the select reference SSB for the target cell corresponds to an SSB configured in a first active bandwidth part of the target cell, an SSB configured in a serving cell measurement object of the target cell, an SSB configured in a bandwidth-part-specific serving cell measurement object of the target cell, if configured, or an SSB configured in a target cell measurement object of the serving cell.

In a fourth aspect, alone or in combination with one or more of the first through third aspects, process 800 includes transmitting priority information for selecting the select reference SSB for the serving cell from the two or more SSBs for the serving cell, or for selecting the select reference SSB for the target cell from the two or more SSBs for the target cell.

In a fifth aspect, alone or in combination with one or more of the first through fourth aspects, transmitting the priority information comprises transmitting downlink control information, a medium access control message, a radio resource control message, system information, or a handover command that includes the priority information,

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

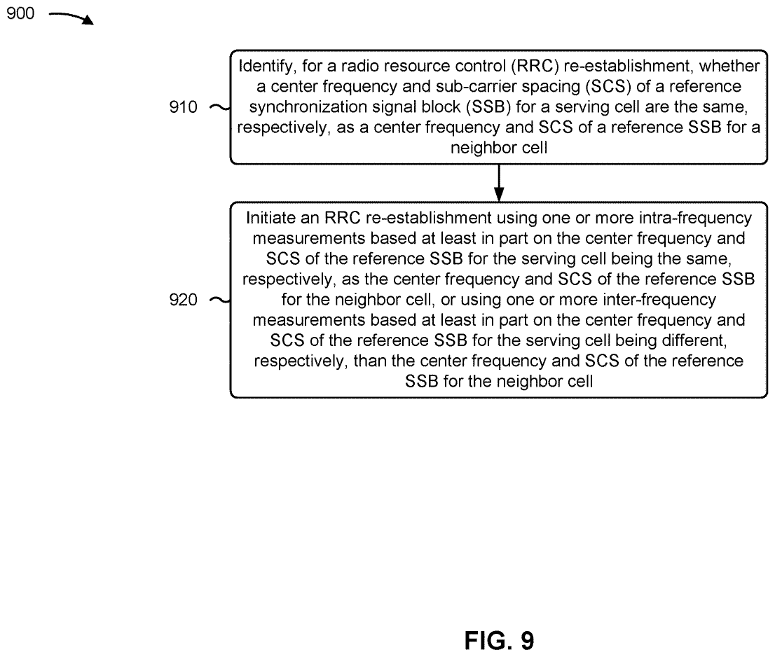

FIG. 9 is a diagram illustrating an example process 900 performed, for example, by a UE, in accordance with the present disclosure. Example process 900 is an example where the UE (e.g., UE 120) performs operations associated with identifying a reference SSB.

As shown in FIG. 9, in some aspects, process 900 may include identifying, for a radio resource control (RRC) re-establishment, whether a center frequency and sub-carrier spacing (SCS) of a reference synchronization signal block (SSB) for a serving cell are the same, respectively, as a center frequency and SCS of a reference SSB for a neighbor cell (block 910). For example, the UE (e.g., using communication manager 1106, depicted in FIG. 11) may identify, for a radio resource control (RRC) re-establishment, whether a center frequency and sub-carrier spacing (SCS) of a reference synchronization signal block (SSB) for a serving cell are the same, respectively, as a center frequency and SCS of a reference SSB for a neighbor cell, as described above.

As further shown in FIG. 9, in some aspects, process 900 may include initiating an RRC re-establishment using one or more intra-frequency measurements based at least in part on the center frequency and SCS of the reference SSB for the serving cell being the same, respectively, as the center frequency and SCS of the reference SSB for the neighbor cell, or using one or more inter-frequency measurements based at least in part on the center frequency and SCS of the reference SSB for the serving cell being different, respectively, than the center frequency and SCS of the reference SSB for the neighbor cell (block 920). For example, the UE (e.g., using communication manager 1106, depicted in FIG. 11) may initiate an RRC re-establishment using one or more intra-frequency measurements based at least in part on the center frequency and SCS of the reference SSB for the serving cell being the same, respectively, as the center frequency and SCS of the reference SSB for the neighbor cell, or using one or more inter-frequency measurements based at least in part on the center frequency and SCS of the reference SSB for the serving cell being different, respectively, than the center frequency and SCS of the reference SSB for the neighbor cell, as described above.

Process 900 may include additional aspects, such as any single aspect or any combination of aspects described below and/or in connection with one or more other processes described elsewhere herein.

In a first aspect, the UE is a reduced capabilities UE.

In a second aspect, alone or in combination with the first aspect, the UE is configured with at least two SSBs for the serving cell or at least two SSBs for the neighbor cell.

In a third aspect, alone or in combination with one or more of the first and second aspects, the at least two SSBs for the serving cell include a cell-defining SSB and one or more non-cell-defining SSBs, and the at least two SSBs for the neighbor cell include a cell-defining SSB and one or more non-cell-defining SSBs.

In a fourth aspect, alone or in combination with one or more of the first through third aspects, the reference SSB for the serving cell corresponds to a cell-defining SSB of the serving cell, an SSB configured in an active bandwidth part of the serving cell, an SSB configured in a serving cell measurement object, or a bandwidth-part-specific serving cell measurement object, if configured.

In a fifth aspect, alone or in combination with one or more of the first through fourth aspects, the reference SSB for the neighbor cell corresponds to a cell-defining SSB, a non-cell-defining SSB of one or more non-cell-defining SSBs, if configured, or an SSB configured in a measurement object for the neighbor cell.

In a sixth aspect, alone or in combination with one or more of the first through fifth aspects, process 900 includes receiving priority information for selecting the reference SSB for the serving cell from a plurality of SSBs for the serving cell, or for selecting the reference SSB for the neighbor cell from a plurality of SSBs for the neighbor cell.

In a seventh aspect, alone or in combination with one or more of the first through sixth aspects, receiving the priority information comprises receiving downlink control information, a medium access control message, a radio resource control message, system information, or a handover command that includes the priority information.

In an eighth aspect, alone or in combination with one or more of the first through seventh aspects, process 900 includes selecting, based at least in part on UE capability information, the reference SSB for the serving cell from a plurality of SSBs for the serving cell, or the reference SSB for the neighbor cell from a plurality of SSBs for the neighbor cell.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

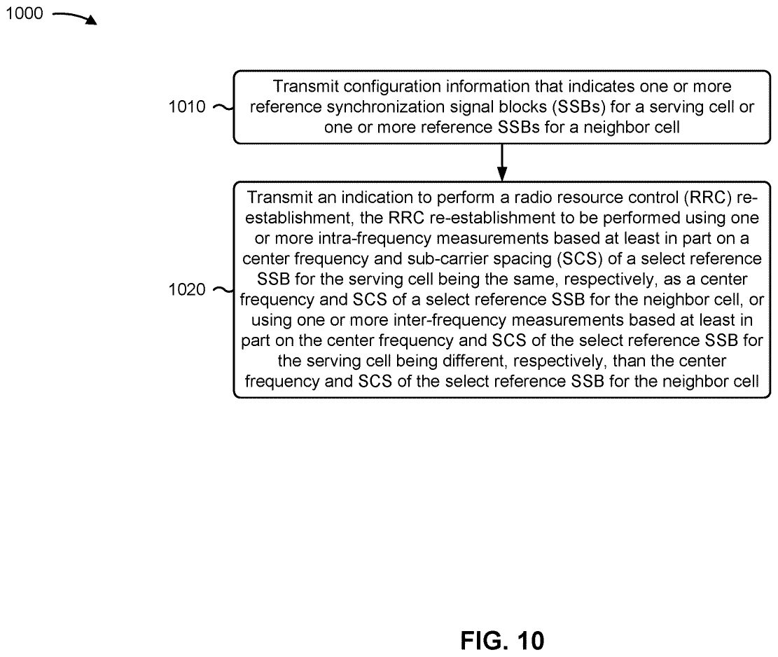

FIG. 10 is a diagram illustrating an example process 1000 performed, for example, by a network node, in accordance with the present disclosure. Example process 1000 is an example where the network node (e.g., network node 110) performs operations associated with identifying a reference SSB.

As shown in FIG. 10, in some aspects, process 1000 may include transmitting configuration information that indicates one or more reference synchronization signal blocks (SSBs) for a serving cell or one or more reference SSBs for a neighbor cell (block 1010). For example, the network node (e.g., using transmission component 1204 and/or communication manager 1206, depicted in FIG. 12) may transmit configuration information that indicates one or more reference synchronization signal blocks (SSBs) for a serving cell or one or more reference SSBs for a neighbor cell, as described above.

As further shown in FIG. 10, in some aspects, process 1000 may include transmitting an indication to perform a radio resource control (RRC) re-establishment, the RRC re-establishment to be performed using one or more intra-frequency measurements based at least in part on a center frequency and sub-carrier spacing (SCS) of a select reference SSB for the serving cell being the same, respectively, as a center frequency and SCS of a select reference SSB for the neighbor cell, or using one or more inter-frequency measurements based at least in part on the center frequency and SCS of the select reference SSB for the serving cell being different, respectively, than the center frequency and SCS of the select reference SSB for the neighbor cell (block 1020). For example, the network node (e.g., using transmission component 1204 and/or communication manager 1206, depicted in FIG. 12) may transmit an indication to perform a radio resource control (RRC) re-establishment, the RRC re-establishment to be performed using one or more intra-frequency measurements based at least in part on a center frequency and sub-carrier spacing (SCS) of a select reference SSB for the serving cell being the same, respectively, as a center frequency and SCS of a select reference SSB for the neighbor cell, or using one or more inter-frequency measurements based at least in part on the center frequency and SCS of the select reference SSB for the serving cell being different, respectively, than the center frequency and SCS of the select reference SSB for the neighbor cell, as described above.

Process 1000 may include additional aspects, such as any single aspect or any combination of aspects described below and/or in connection with one or more other processes described elsewhere herein.

In a first aspect, the one or more reference SSBs for the serving cell include a cell-defining SSB and one or more non-cell-defining SSBs, and the one or more reference SSBs for the neighbor cell include a cell-defining SSB and one or more non-cell-defining SSBs.

In a second aspect, alone or in combination with the first aspect, the select reference SSB for the serving cell corresponds to a cell-defining SSB of the serving cell, an SSB configured in an active bandwidth part of the serving cell, an SSB configured in a serving cell measurement object, or a bandwidth-part-specific serving cell measurement object, if configured.

In a third aspect, alone or in combination with one or more of the first and second aspects, the select reference SSB for the neighbor cell corresponds to a cell-defining SSB, a non-cell-defining SSB of one or more non-cell-defining SSBs, if configured, or an SSB configured in a measurement object for the neighbor cell.

In a fourth aspect, alone or in combination with one or more of the first through third aspects, process 1000 includes transmitting priority information for selecting the select reference SSB for the serving cell from the two or more SSBs for the serving cell, or for selecting the select reference SSB for the neighbor cell from the two or more SSBs for the neighbor cell.

In a fifth aspect, alone or in combination with one or more of the first through fourth aspects, transmitting the priority information comprises transmitting downlink control information, a medium access control message, a radio resource control message, system information, or a handover command that includes the priority information.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 5-6. Additionally, or alternatively, the apparatus 1100 may be configured to perform one or more processes described herein, such as process 700 of FIG. 7, process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The communication manager 1106 may identify, for a handover between a serving cell and a target cell, whether a center frequency and sub-carrier spacing (SCS) of a reference synchronization signal block (SSB) for the serving cell are the same, respectively, as a center frequency and SCS of a reference SSB for the target cell. The communication manager 1106 may initiate a handover from the serving cell to the target cell using one or more intra-frequency measurements or handover conditions based at least in part on the center frequency and SCS of the reference SSB for the serving cell being the same, respectively, as the center frequency and SCS of the reference SSB for the target cell, or using one or more inter-frequency measurements or handover conditions based at least in part on the center frequency and SCS of the reference SSB for the serving cell being different, respectively, than the center frequency and SCS of the reference SSB for the target cell.

The reception component 1102 may receive priority information for selecting the reference SSB for the serving cell from a plurality of SSBs for the serving cell, or for selecting the reference SSB for the target cell from a plurality of SSBs for the target cell.

The communication manager 1106 may select, based at least in part on UE capability information, the reference SSB for the serving cell from a plurality of SSBs for the serving cell, or the reference SSB for the target cell from a plurality of SSBs for the target cell.

The communication manager 1106 may identify, for a radio resource control (RRC) re-establishment, whether a center frequency and sub-carrier spacing (SCS) of a reference synchronization signal block (SSB) for a serving cell are the same, respectively, as a center frequency and SCS of a reference SSB for a neighbor cell. The communication manager 1106 may initiate an RRC re-establishment using one or more intra-frequency measurements based at least in part on the center frequency and SCS of the reference SSB for the serving cell being the same, respectively, as the center frequency and SCS of the reference SSB for the neighbor cell, or using one or more inter-frequency measurements based at least in part on the center frequency and SCS of the reference SSB for the serving cell being different, respectively, than the center frequency and SCS of the reference SSB for the neighbor cell.

The reception component 1102 may receive priority information for selecting the reference SSB for the serving cell from a plurality of SSBs for the serving cell, or for selecting the reference SSB for the neighbor cell from a plurality of SSBs for the neighbor cell. The communication manager 1106 may select, based at least in part on UE capability information, the reference SSB for the serving cell from a plurality of SSBs for the serving cell, or the reference SSB for the neighbor cell from a plurality of SSBs for the neighbor cell.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIG. 5-6. Additionally, or alternatively, the apparatus 1200 may be configured to perform one or more processes described herein, such as process 800 of FIG. 8, process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit configuration information that indicates one or more reference synchronization signal blocks (SSBs) for a serving cell or one or more reference SSBs for a target cell. The transmission component 1204 may transmit an indication to perform a handover from the serving cell to the target cell, the handover to be performed using one or more intra-frequency measurements or handover conditions based at least in part on a center frequency and sub-carrier spacing (SCS) of a select reference SSB for the serving cell being the same, respectively, as a center frequency and SCS of a select reference SSB for the target cell, or using one or more inter-frequency measurements or handover conditions based at least in part on the center frequency and SCS of the select reference SSB for the serving cell being different, respectively, than the center frequency and SCS of the select reference SSB for the target cell.

The transmission component 1204 may transmit priority information for selecting the select reference SSB for the serving cell from the two or more SSBs for the serving cell, or for selecting the select reference SSB for the target cell from the two or more SSBs for the target cell.

The transmission component 1204 may transmit configuration information that indicates one or more reference synchronization signal blocks (SSBs) for a serving cell or one or more reference SSBs for a neighbor cell. The transmission component 1204 may transmit an indication to perform a radio resource control (RRC) re-establishment, the RRC re-establishment to be performed using one or more intra-frequency measurements based at least in part on a center frequency and sub-carrier spacing (SCS) of a select reference SSB for the serving cell being the same, respectively, as a center frequency and SCS of a select reference SSB for the neighbor cell, or using one or more inter-frequency measurements based at least in part on the center frequency and SCS of the select reference SSB for the serving cell being different, respectively, than the center frequency and SCS of the select reference SSB for the neighbor cell.

The transmission component 1204 may transmit priority information for selecting the select reference SSB for the serving cell from the two or more SSBs for the serving cell, or for selecting the select reference SSB for the neighbor cell from the two or more SSBs for the neighbor cell.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: identifying, for a handover between a serving cell and a target cell, whether a center frequency and sub-carrier spacing (SCS) of a reference synchronization signal block (SSB) for the serving cell are the same, respectively, as a center frequency and SCS of a reference SSB for the target cell; and initiating a handover from the serving cell to the target cell using one or more intra-frequency measurements or intra-frequency handover conditions based at least in part on the center frequency and SCS of the reference SSB for the serving cell being the same, respectively, as the center frequency and SCS of the reference SSB for the target cell, or using one or more inter-frequency measurements or inter-frequency handover conditions based at least in part on the center frequency and SCS of the reference SSB for the serving cell being different, respectively, than the center frequency and SCS of the reference SSB for the target cell.
Aspect 2: The method of Aspect 1, wherein the UE is a reduced capabilities UE.
Aspect 3: The method of any of Aspects 1-2, wherein the UE is configured with at least two SSBs for the serving cell or at least two SSBs for the target cell.
Aspect 4: The method of Aspect 3, wherein the at least two SSBs for the serving cell include a cell-defining SSB and one or more non-cell-defining SSBs, and the at least two SSBs for the target cell include a cell-defining SSB and one or more non-cell-defining SSBs.
Aspect 5: The method of any of Aspects 1-4, wherein the reference SSB for the serving cell corresponds to an SSB configured in a serving cell measurement object, an SSB configured in a bandwidth-part-specific serving cell measurement object, if configured, or an SSB configured in an active bandwidth part of the serving cell
Aspect 6: The method of any of Aspects 1-5, wherein the reference SSB for the target cell corresponds to an SSB configured in a first active bandwidth part of the target cell, an SSB configured in a serving cell measurement object of the target cell, an SSB configured in a bandwidth-part-specific serving cell measurement object of the target cell, if configured, or an SSB configured in a target cell measurement object of the serving cell.
Aspect 7: The method of any of Aspects 1-6, further comprising receiving priority information for selecting the reference SSB for the serving cell from a plurality of SSBs for the serving cell, or for selecting the reference SSB for the target cell from a plurality of SSBs for the target cell.
Aspect 8: The method of Aspect 7, wherein receiving the priority information comprises receiving downlink control information, a medium access control message, a radio resource control message, system information, or a handover command that includes the priority information.
Aspect 9: The method of any of Aspects 1-8, further comprising selecting, based at least in part on UE capability information, the reference SSB for the serving cell from a plurality of SSBs for the serving cell, or the reference SSB for the target cell from a plurality of SSBs for the target cell.
Aspect 10: A method of wireless communication performed by a network node, comprising: transmitting configuration information that indicates one or more reference synchronization signal blocks (SSBs) for a serving cell or one or more reference SSBs for a target cell; and transmitting an indication to perform a handover from the serving cell to the target cell, the handover to be performed using one or more intra-frequency measurements or handover conditions based at least in part on a center frequency and sub-carrier spacing (SCS) of a select reference SSB for the serving cell being the same, respectively, as a center frequency and SCS of a select reference SSB for the target cell, or using one or more inter-frequency measurements or handover conditions based at least in part on the center frequency and SCS of the select reference SSB for the serving cell being different, respectively, than the center frequency and SCS of the select reference SSB for the target cell.
Aspect 11: The method of Aspect 10, wherein the one or more reference SSBs for the serving cell include a cell-defining SSB and one or more non-cell-defining SSBs, and the one or more reference SSBs for the target cell include a cell-defining SSB and one or more non-cell-defining SSBs.
Aspect 12: The method of any of Aspects 10-11, wherein the select reference SSB for the serving cell corresponds to an SSB configured in a serving cell measurement object, an SSB configured in a bandwidth-part-specific serving cell measurement object, if configured, or an SSB configured in an active bandwidth part of the serving cell.
Aspect 13: The method of any of Aspects 10-12, wherein the select reference SSB for the target cell corresponds to an SSB configured in a first active bandwidth part of the target cell, an SSB configured in a serving cell measurement object of the target cell, an SSB configured in a bandwidth-part-specific serving cell measurement object of the target cell, if configured, or an SSB configured in a target cell measurement object of the serving cell.
Aspect 14: The method of any of Aspects 10-13, further comprising transmitting priority information for selecting the select reference SSB for the serving cell from the two or more SSBs for the serving cell, or for selecting the select reference SSB for the target cell from the two or more SSBs for the target cell.
Aspect 15: The method of Aspect 14, wherein transmitting the priority information comprises transmitting downlink control information, a medium access control message, a radio resource control message, system information, or a handover command that includes the priority information.
Aspect 16: A method of wireless communication performed by a user equipment (UE), comprising: identifying, for a radio resource control (RRC) re-establishment, whether a center frequency and sub-carrier spacing (SCS) of a reference synchronization signal block (SSB) for a serving cell are the same, respectively, as a center frequency and SCS of a reference SSB for a neighbor cell; and initiating an RRC re-establishment using one or more intra-frequency measurements based at least in part on the center frequency and SCS of the reference SSB for the serving cell being the same, respectively, as the center frequency and SCS of the reference SSB for the neighbor cell, or using one or more inter-frequency measurements based at least in part on the center frequency and SCS of the reference SSB for the serving cell being different, respectively, than the center frequency and SCS of the reference SSB for the neighbor cell.
Aspect 17: The method of Aspect 16, wherein the UE is a reduced capabilities UE.
Aspect 18: The method of any of Aspects 16-17, wherein the UE is configured with at least two SSBs for the serving cell or at least two SSBs for the neighbor cell.
Aspect 19: The method of Aspect 18, wherein the at least two SSBs for the serving cell include a cell-defining SSB and one or more non-cell-defining SSBs, and the at least two SSBs for the neighbor cell include a cell-defining SSB and one or more non-cell-defining SSBs.
Aspect 20: The method of any of Aspects 16-19, wherein the reference SSB for the serving cell corresponds to a cell-defining SSB of the serving cell, an SSB configured in an active bandwidth part of the serving cell, an SSB configured in a serving cell measurement object, or a bandwidth-part-specific serving cell measurement object, if configured.
Aspect 21: The method of any of Aspects 16-20, wherein the reference SSB for the neighbor cell corresponds to a cell-defining SSB, a non-cell-defining SSB of one or more non-cell-defining SSBs, if configured, or an SSB configured in a measurement object for the neighbor cell.
Aspect 22: The method of any of Aspects 16-21, further comprising receiving priority information for selecting the reference SSB for the serving cell from a plurality of SSBs for the serving cell, or for selecting the reference SSB for the neighbor cell from a plurality of SSBs for the neighbor cell.
Aspect 23: The method of Aspect 22, wherein receiving the priority information comprises receiving downlink control information, a medium access control message, a radio resource control message, system information, or a handover command that includes the priority information.
Aspect 24: The method of any of Aspects 16-23, further comprising selecting, based at least in part on UE capability information, the reference SSB for the serving cell from a plurality of SSBs for the serving cell, or the reference SSB for the neighbor cell from a plurality of SSBs for the neighbor cell.
Aspect 25: A method of wireless communication performed by a network node, comprising: transmitting configuration information that indicates one or more reference synchronization signal blocks (SSBs) for a serving cell or one or more reference SSBs for a neighbor cell; and transmitting an indication to perform a radio resource control (RRC) re-establishment, the RRC re-establishment to be performed using one or more intra-frequency measurements based at least in part on a center frequency and sub-carrier spacing (SCS) of a select reference SSB for the serving cell being the same, respectively, as a center frequency and SCS of a select reference SSB for the neighbor cell, or using one or more inter-frequency measurements based at least in part on the center frequency and SCS of the select reference SSB for the serving cell being different, respectively, than the center frequency and SCS of the select reference SSB for the neighbor cell.
Aspect 26: The method of Aspect 25, wherein the one or more reference SSBs for the serving cell include a cell-defining SSB and one or more non-cell-defining SSBs, and the one or more reference SSBs for the neighbor cell include a cell-defining SSB and one or more non-cell-defining SSBs.
Aspect 27: The method of any of Aspects 25-26, wherein the select reference SSB for the serving cell corresponds to a cell-defining SSB of the serving cell, an SSB configured in an active bandwidth part of the serving cell, an SSB configured in a serving cell measurement object, or a bandwidth-part-specific serving cell measurement object, if configured.
Aspect 28: The method of any of Aspects 25-27, wherein the select reference SSB for the neighbor cell corresponds to a cell-defining SSB, a non-cell-defining SSB of one or more non-cell-defining SSBs, if configured, or an SSB configured in a measurement object for the neighbor cell.
Aspect 29: The method of any of Aspects 25-28, further comprising transmitting priority information for selecting the select reference SSB for the serving cell from the two or more SSBs for the serving cell, or for selecting the select reference SSB for the neighbor cell from the two or more SSBs for the neighbor cell.
Aspect 30: The method of Aspect 29, wherein transmitting the priority information comprises transmitting downlink control information, a medium access control message, a radio resource control message, system information, or a handover command that includes the priority information.
Aspect 31: An apparatus for wireless communication at a device, comprising a processor; memory coupled with the processor; and instructions stored in the memory and executable by the processor to cause the apparatus to perform the method of one or more of Aspects 1-30.
Aspect 32: A device for wireless communication, comprising memory, and one or more processors coupled to the memory, the memory comprising instructions executable by the one or more processors to cause the device to perform the method of one or more of Aspects 1-30.
Aspect 33: A device for wireless communication, comprising a memory and one or more processors coupled to the memory, the one or more processors configured to perform the method of one or more of Aspects 1-30.
Aspect 34: An apparatus for wireless communication, comprising at least one means for performing the method of one or more of Aspects 1-30.
Aspect 35: A non-transitory computer-readable medium storing code for wireless communication, the code comprising instructions executable by a processor to perform the method of one or more of Aspects 1-30.
Aspect 36: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c+b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors coupled to the one or more memories, the one or more memories comprising instructions executable by the one or more processors to cause the UE to:
identify, for a handover between a serving cell and a target cell, whether a center frequency and sub-carrier spacing (SCS) of a reference synchronization signal block (SSB) for the serving cell are the same, respectively, as a center frequency and SCS of a reference SSB for the target cell; and
initiate a handover from the serving cell to the target cell using one or more intra-frequency measurements or intra-frequency handover conditions based at least in part on the center frequency and SCS of the reference SSB for the serving cell being the same, respectively, as the center frequency and SCS of the reference SSB for the target cell, or using one or more inter-frequency measurements or inter-frequency handover conditions based at least in part on the center frequency and SCS of the reference SSB for the serving cell being different, respectively, than the center frequency and SCS of the reference SSB for the target cell.

2. The UE of claim 1, wherein the UE is a reduced capabilities UE.

3. The UE of claim 1, wherein the UE is configured with at least two SSBs for the serving cell or at least two SSBs for the target cell.

4. The UE of claim 3, wherein the at least two SSBs for the serving cell include a cell-defining SSB and one or more non-cell-defining SSBs, and the at least two SSBs for the target cell include a cell-defining SSB and one or more non-cell-defining SSBs.

5. The UE of claim 1, wherein the reference SSB for the serving cell corresponds to an SSB configured in a serving cell measurement object, an SSB configured in a bandwidth-part-specific serving cell measurement object, if configured, or an SSB configured in an active bandwidth part of the serving cell.

6. The UE of claim 1, wherein the reference SSB for the target cell corresponds to an SSB configured in a first active bandwidth part of the target cell, an SSB configured in a serving cell measurement object of the target cell, an SSB configured in a bandwidth-part-specific serving
cell measurement object of the target cell, if configured, or an SSB configured in a target cell measurement object of the serving cell.

7. The UE of claim 1, wherein the one or more memories further comprise instructions executable by the one or more processors to cause the UE to receive priority information for selecting the reference SSB for the serving cell from a plurality of SSBs for the serving cell, or for selecting the reference SSB for the target cell from a plurality of SSBs for the target cell.

8. The UE of claim 7, wherein the instructions, executable to cause the UE to receive the priority information, are executable to cause the UE to receive downlink control information, a medium access control message, a radio resource control message, system information, or a handover command that includes the priority information.

9. The UE of claim 1, wherein the one or more memories further comprise instructions executable by the one or more processors to cause the UE to select, based at least in part on UE capability information, the reference SSB for the serving cell from a plurality of SSBs for the serving cell, or the reference SSB for the target cell from a plurality of SSBs for the target cell.

10. A network node for wireless communication, comprising:
one or more memories; and
one or more processors coupled to the one or more memories, the one or more memories comprising instructions executable by the one or more processors to cause the network node to:
transmit configuration information that indicates one or more reference synchronization signal blocks (SSBs) for a serving cell or one or more reference SSBs for a target cell; and
transmit an indication to perform a handover from the serving cell to the target cell, the handover to be performed using one or more intra-frequency measurements or intra-frequency handover conditions based at least in part on a center frequency and sub-carrier spacing (SCS) of a select reference SSB for the serving cell being the same, respectively, as a center frequency and SCS of a select reference SSB for the target cell, or using one or more inter-frequency measurements or inter-frequency handover conditions based at least in part on the center frequency and SCS of the select reference SSB for the serving cell being different, respectively, than the center frequency and SCS of the select reference SSB for the target cell.

11. The network node of claim 10, wherein the one or more reference SSBs for the serving cell include a cell-defining SSB and one or more non-cell-defining SSBs, and the one or more reference SSBs for the target cell include a cell-defining SSB and one or more non-cell-defining SSBs.

12. The network node of claim 10, wherein the select reference SSB for the serving cell corresponds to an SSB configured in a serving cell measurement object, an SSB configured in a bandwidth-part-specific serving cell measurement object, if configured, or an SSB configured in an active bandwidth part of the serving cell.

13. The network node of claim 10, wherein the select reference SSB for the target cell corresponds to an SSB configured in a first active bandwidth part of the target cell, an SSB configured in a serving cell measurement object of the target cell, an SSB configured in a bandwidth-part-specific serving cell measurement object of the target cell, if configured, or an SSB configured in a target cell measurement object of the serving cell.

14. The network node of claim 10, wherein the one or more memories further comprise instructions executable by the one or more processors to cause the network node to transmit priority information for selecting the select reference SSB for the serving cell from two or more SSBs for the serving cell, or for selecting the select reference SSB for the target cell from two or more SSBs for the target cell.

15. The network node of claim 14, wherein the instructions, executable to cause the network node to transmit the priority information, are executable to cause the network node to transmit downlink control information, a medium access control message, a radio resource control message, system information, or a handover command that includes the priority information.

16. A UE for wireless communication, comprising:
one or more memories; and
one or more processors coupled to the one or more memories, the one or more memories comprising instructions executable by the one or more processors to cause the UE to:
identify, for a radio resource control (RRC) re-establishment, whether a center frequency and sub-carrier spacing (SCS) of a reference synchronization signal block (SSB) for a serving cell are the same, respectively, as a center frequency and SCS of a reference SSB for a neighbor cell; and
initiate an RRC re-establishment using one or more intra-frequency measurements based at least in part on the center frequency and SCS of the reference SSB for the serving cell being the same, respectively, as the center frequency and SCS of the reference SSB for the neighbor cell, or using one or more inter-frequency measurements based at least in part on the center frequency and SCS of the reference SSB for the serving cell being different, respectively, than the center frequency and SCS of the reference SSB for the neighbor cell.

17. The UE of claim 16, wherein the UE is a reduced capabilities UE.

18. The UE of claim 16, wherein the UE is configured with at least two SSBs for the serving cell or at least two SSBs for the neighbor cell.

19. The UE of claim 18, wherein the at least two SSBs for the serving cell include a cell-defining SSB and one or more non-cell-defining SSBs, and the at least two SSBs for the neighbor cell include a cell-defining SSB and one or more non-cell-defining SSBs.

20. The UE of claim 16, wherein the reference SSB for the serving cell corresponds to a cell-defining SSB of the serving cell, an SSB configured in an active bandwidth part of the serving cell, an SSB configured in a serving cell measurement object, or a bandwidth-part-specific serving cell measurement object, if configured.

21.-30. (canceled)
